(19) United States
(12) Patent Application Publication
(10) Pub. No.: US 2009/0276640 A1
(43) Pub. Date: Nov. 5, 2009

(54) POWER MANAGEMENT APPARATUS AND SYSTEM USING THE SAME

(75) Inventor: Li-Chien Wu, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTEK COMPUTER INC., Taipei (TW)

(21) Appl. No.: 12/423,018

(22) Filed: Apr. 14, 2009

(30) Foreign Application Priority Data
May 5, 2008 (TW) 97116529

(51) Int. Cl. G06F 1/26

(52) U.S. Cl. 713/300

(57) ABSTRACT

A power management apparatus and a system using the same, which are suitable for managing power supplies for peripheral devices connected to a host system, are provided. The power management apparatus includes power supply switches, a control circuit and a power supply unit. The power supply switches are respectively coupled between the peripheral devices and the power supply unit. The control circuit determines whether or not operating powers are supplied to the corresponding peripheral devices through the power supply switches according to a control signal outputted from the host system.

### CROSS-REFERENCE TO RELATED APPLICATION

This application claims the priority benefit of Taiwan application serial no. 97116529, filed on May 5, 2008. The entirety of the above-mentioned patent application is hereby incorporated by reference herein and made a part of specification.

### BACKGROUND OF THE INVENTION

1. Field of the Invention

The present invention relates to a power management apparatus, and more particularly to a power management apparatus suitable for managing peripheral devices of a computer and a system using the same.

2. Description of Related Art

As consciousness of environmental protection has risen rapidly in recent years, electronic products equipped with energy-saving functions have gradually become the trend. The energy-saving technique in personal computers, displays and peripheral devices thereof particularly features as the focus of development. For example, light emitting diodes (LED) replace cold cathode fluorescent lamps (CCFL) as the backlight source for liquid crystal displays (LCD), or highly efficient power supplies are developed.

In addition to enhancing the power efficiency of electronic devices themselves, the use habit of a user is also the key to energy saving. If the user can turn off the electronic devices as soon as they are left standby, electricity can be saved more effectively. As computer functions diversify, a computer requires more and more peripheral devices, e.g., amplifiers, modems, TV boxes, displays and printers. However, powers of the peripheral devices cannot be controlled through a unified interface, and the user usually needs to manually turn on or turn off the powers of the peripheral devices one by one, which causes inconvenience in use.

Besides, since the positions of the peripheral devices are usually located in different corners, the user would feel too lazy to turn them off one by one but rather leave them standby instead, which directly results in poor use efficiency of the powers and waste of electricity.

### SUMMARY OF THE INVENTION

The present invention provides a power management apparatus, suitable for managing power supplies of a plurality of peripheral devices of a host system. The power management apparatus is suitable for managing the power supplies of the plurality of peripheral devices and includes a power supply unit, a control circuit and a plurality of power supply switches. The power supply unit receives an external power and generates at least one internal power supply. The power supply switches are respectively coupled between one of the peripheral devices and the power supply unit correspondingly. The control circuit sends a plurality of switch signals to the corresponding power supply switches to determine whether or not the internal power supplies are supplied to the peripheral devices.

The present invention further provides a power management system suitable for managing a plurality of peripheral devices. The power management system includes a host system and a power management apparatus. The host system is used for outputting a control signal, and the power management apparatus includes a power supply unit, a plurality of power supply switches and a control circuit. The power supply unit is used for receiving an external power and generating at least one internal power supply. The power supply switches are respectively coupled between one of the peripheral devices and the power supply unit. The control circuit sends a plurality of switch signals to the corresponding power supply switches to determine whether or not the internal power supplies are supplied to the peripheral devices according to the control signal.

In the present invention, the power supplies of all the peripheral devices are controlled through the power management apparatus, and the user directly controls the power supplies of all the peripheral devices through a software interface provided by the host system (computer) such that the user performs power management more conveniently.

In order to make the aforementioned and other objects, features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 shows a power management system diagram according to the first embodiment of the present invention.

FIG. 2 shows a power management system diagram according to the second embodiment of the present invention.

### DESCRIPTION OF EMBODIMENTS

### The First Embodiment

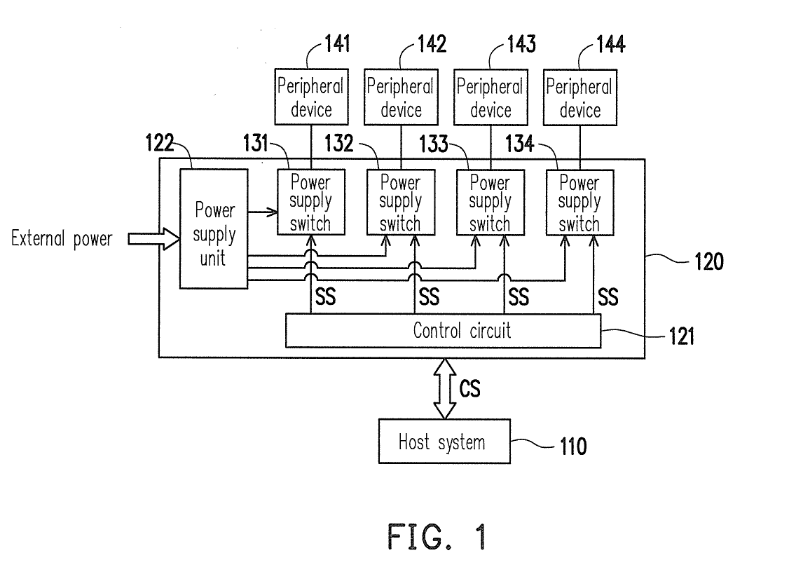

FIG. 1 shows a power management system diagram according to the first embodiment of the present invention. The power management system includes a host system 110 and a power management apparatus 120. The power management apparatus 120 includes a control circuit 121, a power supply unit 122 and power supply switches 131-134. The power supply unit 122 is used for receiving an external power and generating internal power supplies to the power supply switches 131-134. The power supply switches 131-134 are coupled between the power supply unit 122 and peripheral devices 141-144. The control circuit 121 is coupled to the power supply switches 131-134 and outputs a plurality of switch signals SS to the corresponding power supply switches 131-134 according to a control signal CS outputted from the host system 110 so as to determine whether or not the internal power supplies are supplied to the peripheral devices 141-144.

The external power received by the power management apparatus 120 is directly provided by local electricity (e.g., an alternating current of 110V) or the host system, and the internal power supplies may be determined according to operating voltages required by different peripheral devices 141-144. The host system 110 is a computer host (or a motherboard), for example. The host system 110 and the control circuit 121 may be connected with each other through a system management bus (SMBUS). The control circuit 121 is, for example, a power control chip, and outputs the switch signal SS to the corresponding power supply switches 131-134 according to the control signal CS outputted from the host system 110 so as to determine whether or not the internal power supplies generated by the power supply unit 122 are supplied to the peripheral devices 141-144.

The host system 110 may use an application program (i.e., software program) to integrate all the peripheral devices 141-144 (e.g., printer, amplifier, display or modem) into the same user interface. The user may use an input device, such as a mouse or a keyboard, to control all of the powers of the peripheral devices 141-144 connected to the power management apparatus 120. The power supply switches 131-134 may include a relay or an analogous switch responsible for switching the powers of the peripheral devices 141-144 and include a socket for connecting to the peripheral devices 141-144.

Additionally, the control circuit 121 may set a power supply state corresponding to a power management state of a basic input/output system (BIOS) in the host system 110, such as explanations of S1, S3 and S5 standards. Please refer to the advanced configuration and power interface (ACPI) for more details on this aspect. For example, in a state S1, one of the power supply switches corresponding to a screen turns off the power, and in a state S3 or S5, all the power supply switches turn off the powers. A form of the power management apparatus 120 is, for example, a power extension line. As long as the control circuit 121 and the power supply switches 131-134 are integrated into the power extension line, the host system 110 can switch the power supply state of each of the peripheral devices 141-144 through the control circuit 121.

Moreover, it should be noted that the user may also control the control circuit 121 in a wireless manner through a remote control so as to determine whether or not the powers are supplied to the peripheral devices 141-144. For more details about the wireless manner, please refer to the following embodiments.

### The Second Embodiment

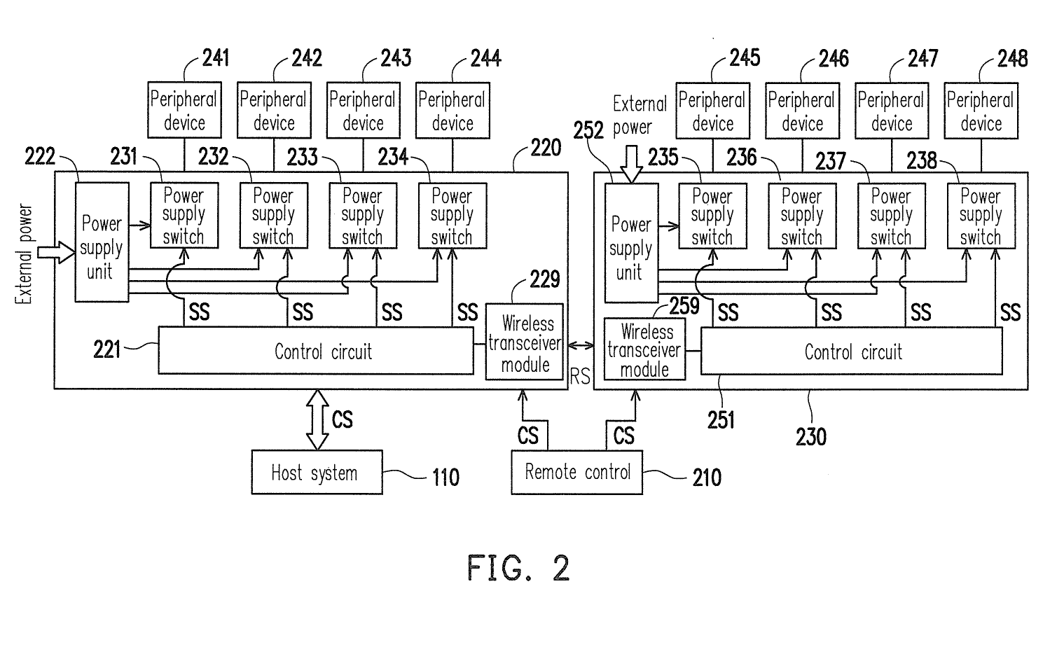

FIG. 2 shows a power management system diagram according to the second embodiment of the present invention. FIGS. 2 and 1 differ from each other mainly in wireless transceiver modules 229 and 259 and a remote control 210. As shown by FIG. 2, the power management system includes a host system 110, a remote control 210 and power management apparatuses 220 and 230. The power management apparatus 220 includes a control circuit 221, a wireless transceiver module 229 and power supply switches 231-234. The power management apparatus 230 includes a control circuit 251, a wireless transceiver module 259 and power supply switches 235-238. The power management apparatus 230 may be optionally disposed according to the user's actual needs.

Peripheral devices 241-244 and 245-248 are correspondingly coupled to the power supply switches 231-234 and 235-238 to obtain powers required by operation. The power management apparatuses 220 and 230 may communicate with each other through the wireless transceiver modules 229 and 259. When the host system 110 outputs a control signal CS to the power management apparatus 220, the power management apparatus 220 determines whether or not the powers are supplied to the peripheral devices 241-244 according to the control signal CS, and converts the control signal CS into a wireless radio frequency signal RS to be transmitted to the power management apparatus 230 through the wireless transceiver module 229 so as to determine whether or not the powers are supplied to the peripheral devices 245-248.

In other words, according to the present embodiment, a power management apparatus section is divided into the power management apparatuses 220 and 230, which communicate and connect with each other in a wireless manner. The host system 110 or the remote control 210 only needs to transmit the control signal CS to any one of the power management apparatuses (e.g., the power management apparatus 220) to control whether or not all of the peripheral devices 241-248 are supplied with power. After receiving a remote signal outputted by the remote control 210, the wireless transceiver module 229 or 259 generates a triggering signal to the corresponding control circuit 221 or 251 so that the control circuit 221 or 251 is controlled to generate switch signals SS to the corresponding power supply switches 231-234 or 235-238 to determine whether or not internal power supplies generated by power supply units 222 or 252 are supplied to the peripheral devices 241-248. Other operation details of the embodiment shown in FIG. 2 can be referred to the description of the first embodiment and are therefore not repeated hereinafter.

Additionally, it should be noted that the power management apparatus section may include one or a plurality of power management apparatuses. When the power management apparatus section includes a plurality of power management apparatuses, each of the power management apparatuses is connected to one another through the wireless transceiver modules. When the power management apparatus section includes only one power management apparatus, the wireless transceiver module is mainly used for receiving the control signal outputted by the remote control.

In summary, the power supply switches of the peripheral devices are directly controlled to turn on or turn off the powers by the host system in the present invention. Therefore, the user directly controls the control signal desired to be inputted by the host system through the user interface, which provides an image option and an input device and may be achieved by running an application program or a software program. As a result, it is determined whether or not each of the peripheral devices is supplied with power without having to switch the power supply switches of all the peripheral devices one by one to turn off or turn on the powers of the corresponding peripheral devices, thereby increasing the convenience of power management for the user. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A power management apparatus, suitable for managing power supplies for a plurality of peripheral devices, the power management apparatus comprising:
a power supply unit, receiving an external power and generating a plurality of internal power supplies;
a plurality of power supply switches, respectively coupled between one of the peripheral devices and the power supply unit correspondingly; and
a control circuit, outputting a plurality of switch signals to the corresponding power supply switches to determine whether or not any one of the internal power supplies is supplied to the peripheral devices.

2. The power management apparatus of claim 1, wherein the internal power supplies are voltages of an identical level.

3. The power management apparatus of claim 1, wherein the peripheral devices comprise a printer, an amplifier, a display or a modem.

4. The power management apparatus of claim 1, further comprising a wireless transceiver module generating a triggering signal to the control circuit to generate the switch signals according to a remote signal.

5. A power management system, suitable for managing a plurality of peripheral devices, the power management system comprising:
a host system, used for outputting a control signal; and
a power management apparatus, comprising:
a power supply unit, receiving an external power and generating a plurality of internal power supplies;
a plurality of power supply switches, respectively coupled between one of the peripheral devices and the power supply unit correspondingly; and
a control circuit, outputting a plurality of switch signals to the corresponding power supply switches to determine whether or not any one of the internal power supplies is supplied to the peripheral devices.

6. The power management system of claim 5, wherein the internal power supplies are voltages of an identical level.

7. The power management system of claim 5, wherein the peripheral devices comprise a printer, an amplifier, a display or a modem.

8. The power management system of claim 5, further comprising a wireless transceiver module generating a triggering signal to the control circuit to generate the switch signals according to a remote signal.

9. The power management system of claim 5, wherein the host system further comprises a user interface for selecting the control signal to be outputted.

10. The power management system of claim 5, wherein the external power is provided by the host system.
